(19) United States
(12) Patent Application Publication
(10) Pub. No.: US 2023/0372847 A1
(43) Pub. Date: Nov. 23, 2023

(54) AIR FILTER AND METHOD FOR PREVENTING TRANSMISSION OF INFECTIONS

(71) Applicant: Lainisalo Capital OÜ, Tallinn (EE)

(72) Inventor: Pertti LAINISALO, Tallinn (EE)

(73) Assignee: Lainisalo Capital OÜ, Tallinn (EE)

(21) Appl. No.: 18/030,125

(22) PCT Filed: Sep. 14, 2021
(86) PCT No.: PCT/EP2021/075209

§ 371 Date: Apr. 4, 2023

(30) Foreign Application Priority Data
Oct. 12, 2020 (FI) 20205999

(51) Int. Cl. B01D 39/08

(52) U.S. Cl. CPC B01D 39/083; B01D 2239/0241; B01D 2239/0442; B01D 2239/0492; B01D 2239/086; F24F 8/108

(57) ABSTRACT

Disclosed is the use of an active ingredient comprising a plurality of particles having a core of metallic copper with an electrically conductive coating comprising silver for inactivating infection-transmitting micro-organisms. An air filter comprises an air-permeable filter body, the active ingredient and a binder for binding the active ingredient to the air-permeable filter body.

### FIELD

The present disclosure relates to preventing transmission of infections. In particular, the disclosure relates to filtering air for this purpose.

### BACKGROUND

Various infections, such as bacterial or viral infections, follow an aerial route at least in some part of their transmission path. Various means for inactivating any micro-organisms causing the infections exist but these vary in efficiency and may be therefore suitable only for certain applications.

Filtering air has earlier been found as a potent way of preventing transmission of such infections. However, the efficiency of prevention varies depending on the filter.

### OBJECTIVE

An objective is to facilitate improved prevention for transmission of infections. This may be done by improved filtering of air.

In particular, it is an objective to provide filtering with an improved prevention efficiency for one or more types of infections.

Moreover, it is an objective to provide filtering which can provide improved efficiency coarse filtering in conjunction of various filtering structures.

Another objective is to provide a cost-efficient solution.

Finally, it is an objective to provide a solution that does not suffer from risks of synthetic products.

### SUMMARY

In accordance with the present disclosure, it has been found that a specific active ingredient may be used for preventing transmission of infections. This active ingredient may be particularly effectively used for air filtering as it has been found to allow inactivating infection-transmitting micro-organisms in a relatively short amount of time. This is particularly important for air filtering, where the infection-transmitting micro-organisms move along the air flow. In addition, various ways have been found how this active ingredient can be embedded in an air filter for effectively preventing the transmissions. This not only includes reducing the time required to inactivate micro-organisms by using an improved efficiency active ingredient but also increasing the probability for the micro-organisms to interact with the active ingredient. The disclosed solutions may be used for filtering breathing air, including air directly from exhalation and/or air for inhalation. This includes ambient air filtering, for example for confined spaces such as rooms or vehicles.

The active ingredient allows inactivating infection-transmitting micro-organisms, such as viruses and/or bacteria. Inactivating may include killing the micro-organisms or modifying them to remove their capability for transmitting an infection. In particular, the active ingredient may be used for coarse filtering with this purpose. In accordance with the present disclosure, transmission of infections may thereby be prevented by inactivating infection-transmitting micro-organisms, such as viruses and/or bacteria. This may be done for various types of transmission involving infection-transmitting micro-organisms being transmitted through the air, for example for airborne and/or droplet transmission of infections.

While the micro-organisms in question may be any microscopic organisms, including fungi such as mould and/or bacteria, one particularly advantageous practical utilization has been found when the microorganisms are viruses, such as respiratory viruses. In particular, it has been found that the present disclosure may be used for preventing transmission of corona viruses, including SARS-CoV-1 and/or SARS-CoV-2.

According to a first aspect, an air filter for preventing transmission of infections is disclosed. The filter is an air-permeable filter and thereby comprises an air-permeable filter body. The filter further comprises an active ingredient comprising or consisting of a plurality of particles having a core of metallic copper with an electrically conductive coating comprising or consisting of silver. Importantly, the plurality of particles can thereby be electrically conducting. The filter also comprises a binder for binding the active ingredient to the air-permeable filter body. This allows the active ingredient, comprising or consisting of metallic particles, to be embedded into the filter body.

The active ingredient has been found to provide improved inactivation for bacteria and viruses. For example, a prominent effect has been observed for respiratory viruses such as coronaviruses, particularly SARS-CoV-2. In addition, the silver in these hybrid particles allows slowing down or even preventing the oxidation of copper, thereby keeping the structure open and efficient for an extended period of time.

The air filter can be structured to allow a fluid, such as air, carrying infection-transmitting micro-organisms to permeate the filter body. The fluid may comprise liquid, such as droplets, carrying the micro-organisms. It is noted that air flow together with any moisture in the air may facilitate generation of static electricity, which may be effectively utilized with the electrically conductive active ingredient to inactivate infection-transmitting microorganisms. Any liquid in the air may condense in the filter body, thereby slowing down the transmission of the micro-organisms through the filter body.

In accordance with this disclosure, a “filtering plane” may refer to a plane perpendicular to the air flow direction for filtering. The air flow direction may thereby correspond to the depth dimension of the filter body and thus also that of the air filter. The filtering plane may extend along the whole width and/or height of the filter body, i.e. the lateral dimensions of the air filter. The filtering plane may extend in the depth dimension of the air filter along the whole or partial depth of the filter. Correspondingly, passing “through” the filter may refer to passing from one side of the filter to another in the air flow direction and through the filtering plane.

The active ingredient may be embedded in the filter body while leaving the filter body air-permeable. This is because the active ingredient may interact rapidly with any infection-transmitting micro-organisms it comes into contact with and it will therefore be enough to apply the active ingredient on a selection of inner and/or outer surfaces of the filter body. The active ingredient may therefore be used as an inner and/or an outer coating for the filter body, in the sense that it may coat any inner and/or outer surfaces of the filter body. Naturally, the active ingredient may still be applied throughout the filter body. In particular, the active ingredient may be applied across the whole the filtering plane, thereby providing a plane, where all surfaces of the filter body are coated with the active ingredient and through which any infection-transmitting microorganisms need to pass to pass through the filter body. The active ingredient may also thereby fill the filtering plane in an air-permeable manner, while mitigating the transmission of the micro-organisms through the filtering plane. The active ingredient may also be applied across the whole depth dimension of the filter body, which not only allows the probability of interaction between the active ingredient and the infection-transmitting micro-organisms to be markedly increased, but also allows the filter to be manufactured in an effective manner, for example by immersion, e.g. in a liquid bath.

In an embodiment, the filter body comprises or consists of a threaded mesh, which can extend through the filter body. This not only allows air to pass through the filter body but it has been found to provide a particularly effective balance of supporting the active ingredient while allowing the active ingredient to be spread easily and widely into the filter body. For providing the threaded mesh, the filter body may comprise or consist of any of the following, alone or in combination: a fiberglass filter, an open-porous mesh and a cloth filter.

In general, it has been found that the active ingredient comprising or consisting of metallic particles, including said plurality of particles, may be used to provide particularly improved inactivation. This can be at least partially facilitated by the electrical conductivity of the metallic particles. In addition to the plurality of particles, the active ingredient may comprise other metallic particles. In particular those of silver and/or gold have been found to provide particularly improved inactivation for various applications. The metallic particles may be provided as a pigment, for example as a coating pigment. Such pigments have been provided, for example, for surface coating.

In an embodiment, the active ingredient comprises at least 90 percent by weight of the plurality of particles. This has been found particularly effective for the air filtering application, where a rapid inactivation of infection-transmitting micro-organisms provides one way for improving the efficiency of filtering. Reducing the time required for inactivation of the micro-organisms allows increasing the inactivation probability even without increasing the time the micro-organisms are interacting with the active ingredient. This mitigates the need of slowing or redirecting the flow of air, or that of the micro-organisms.

In an embodiment, the active ingredient comprises additional metallic particles, which are silver particles and/or metallic gold particles. In a further embodiment, the active ingredient comprises 1-10 percent by weight of the additional particles. In particular, including silver particles has been found to provide particularly effective inactivation for certain bacteria and viruses, including SARS-CoV-2. On the other hand, including gold particles has been found to allow increasing electrical conductivity, which may provide particular effectiveness in various applications. Inclusion of gold particles can also be used to ensure the electric power distribution ability of the active ingredient.

In general, the active ingredient can be electrically conductive, regardless of whether it comprises additional metallic particles, such as the gold particles and/or the silver particles, or not. However, the inclusion of the silver and/or gold particles allows easily providing slight modifications to the inactivation properties of the active ingredient, thereby allowing for example the inactivation of the active ingredient to be adjusted for a specific application and/or micro-organism. In all case, the active ingredient can be embedded in the filter body in such a manner that an electrically conductive connection can be formed across the filtering plane or even across the whole filter body.

In an embodiment, the plurality of particles are microparticles. Using microparticles has been found not only to be effective for inactivation but they can also be effectively embedded into the filter body. As an example, the core of the plurality of particles may have a diameter of 1-100 micrometers. In various preferable embodiments, in particular pertaining to inactivating respiratory viruses, the core may have a diameter of 5-50 micrometers. These same values may be applied for any or all other metallic particles included in the active ingredient, in particular the silver and/or gold particles. On the other hand, the coating for the plurality of particles may be substantially thinner and it may form a thin film covering the core.

When the active ingredient comprises the silver and/or gold particles as described above, these may also be microparticles as described above. The active ingredient may thus consist of microparticles. In some examples, any such particles may have a diameter of 1-100 micrometers.

In an embodiment, the thickness of the coating is less than a micrometer, for example 10-100 nanometers or even less. The coating may thus function as a thin film on top of the core.

In an embodiment, the air filter comprises an electrical connection for directing electric current into the active ingredient. This may be used to allow increase in the inactivation efficiency of the filter. The solution can be used particularly for an air filter of a ventilation and/or an air conditioning apparatus, for example that of an air changing unit.

In an embodiment, the binder comprises one or more from a group consisting of an alkyd, epoxy, latex, polymethyl methacrylate (PMMA) and polyurethane. In particular, the binder may be selected from this group. Specific binders have been found to have application-specific advantages. For example, an alkyd may be used to act as a mild binder with cost-benefits. PMMA may be used for improved durability under abrasion and ultraviolet light, making it particularly advantageous for outdoor use. Polyurethane may be used for improved durability under abrasion, ultraviolet light, chemicals and humidity, making it particularly advantageous not only for outdoor use but also for more demanding applications such as bathing sites and medical sites. Alkyd and/or epoxy facilitate particularly well the manufacture of the air filter by dip coating for coating any inner surfaces of the filter body with the active ingredient. In an embodiment, the air filter comprises a first air-permeable post-filter positioned against the filter body for mitigating the escape of infection-transmitting microorganisms from the filter body. This allows the microorganisms to be maintained within the filter body for an extended time and thereby being subjected to increased interaction with the active ingredient, thereby markedly increasing inactivation. The post-filter may also slow transmission of the micro-organisms through the filter body by increase condensation of any fluid carrying the micro-organisms within the filter body. Moreover, the post-filter may be used to protect a user of the filter from contact with the active ingredient, which may be particularly advantageous for a personal-use filter.

In an embodiment, the air filter comprises a second air-permeable post-filter positioned against the filter body for mitigating the escape of infection-transmitting micro-organisms from the filter body. The filter body is sandwiched between the first and the second post-filter allowing the microorganisms to be trapped in the air-flow direction within the filter body for an extended period of time.

In an embodiment, the active ingredient is provided on one or more outer surfaces, such as the front and/or the rear surface (in the airflow direction), of the filter body as a surface application. The air filter can thereby, at some depth range, be free of the active ingredient. This region may extend across the majority of the depth dimension of the air filter. It may include the front or rear surface of the air filter. This allows providing particularly effective filters for various applications, for example HEPA filters and/or non-circulating air filters.

According to a second aspect, a face mask comprises the air filter according to the first aspect or any of its embodiments, alone or in combination, for filtering breathing air.

According to a third aspect, a ventilation and/or air conditioning apparatus comprises the air filter according to the first aspect or any of its embodiments, alone or in combination, for filtering air passing through the apparatus.

According to a fourth aspect, a method for preventing transmission of infections is disclosed. The method comprises filtering air by an active ingredient comprising a plurality of particles having a core of metallic copper with an electrically conductive coating comprising or consisting of silver. The features disclosed in connection of any of the other aspects or embodiments thereof may be applied for the method as well.

According to a fifth aspect, an active ingredient comprising a plurality of particles having a core of metallic copper with an electrically conductive coating comprising or consisting of silver is used for inactivating infection-transmitting microorganisms. In particular, this may be used for filtering breathing air.

According to a sixth aspect, a method of manufacturing an apparatus for inactivating infection-transmitting micro-organisms may comprise coating one or more inner and/or outer surfaces of the apparatus with the active ingredient as disclosed herein. The apparatus may be an air-filtering apparatus, in particular for filtering breathing air as disclosed herein. Further, the coating may be performed by dip and/or spray coating.

According to a seventh aspect, a filter roll is discloses. The filter roll comprises a plurality of air filters according to the first aspect or any of its embodiments, alone or in any combination. The plurality of air filters can be joined together as a chain where subsequent air filters are detachable from each other.

In an embodiment, the plurality of air filters are HEPA filters.

According to an eighth aspect, a method of manufacturing the air filter according to the first aspect or any of its embodiments, alone or in any combination, is disclosed. The method comprises spray coating one or more outer surfaces of the filter body with the active ingredient. This can be performed with a automatized spray coating device such as a spray coating robot.

It is to be understood that the aspects and embodiments described above may be used in any combination with each other. Several of the aspects and embodiments may be combined together to form a further embodiment of the invention. When same expressions are used in the context of different aspects or embodiments, the corresponding features can be applied in all of the aspects and embodiments.

Some important further effects that may be provided by the solutions as disclosed include the versatility for various applications. The air filter may be taken into use relatively effortlessly and quickly and its maintenance can be easily arranged. It may be provided as a coarse filter, which may be replaceable. The structure of the filter allows it to be provided at various sizes, including ones suitable for face masks, air conditioners or air changing units. The filter may be shaped or shapeable to match any surface shape. For this purpose, the filter body may be of flexible material and the active ingredient may be bound into it in a manner to maintain flexibility. In typical applications, the filter body may be substantially shaped as a plane, which may be curved or flat.

At the filter body, the active ingredient may be arranged for coming into direct contact with the infection-transmitting micro-organisms, thereby allowing the filter to inactivate the micro-organisms. Utilizing copper and silver, and optionally gold, which are natural materials for the active ingredient, allows any risks from synthetic materials to be mitigated or removed altogether. In a simple form, the active ingredient may consist only of metallic particles, which may comprise or consist of silver-covered copper particles.

### BRIEF DESCRIPTION OF THE DRAWINGS

The accompanying drawings, which are included to provide a further understanding and constitute a part of this specification, illustrate examples and together with the description help to explain the principles of the disclosure. In the drawings:

FIG. 1 schematically illustrates an air filter according to an example,

FIG. 2 illustrates a method according to an example,

FIG. 3 illustrates some test results obtained for the active ingredient, and

FIG. 4 schematically illustrates an air filter according to an example.

Like references are used to designate equivalent or at least functionally equivalent parts in the accompanying drawings.

### DETAILED DESCRIPTION

The detailed description provided below in connection with the appended drawings is intended as a description of examples and is not intended to represent the only forms in which the example may be constructed or utilized. However, the same or equivalent functions and structures may be accomplished by different examples.

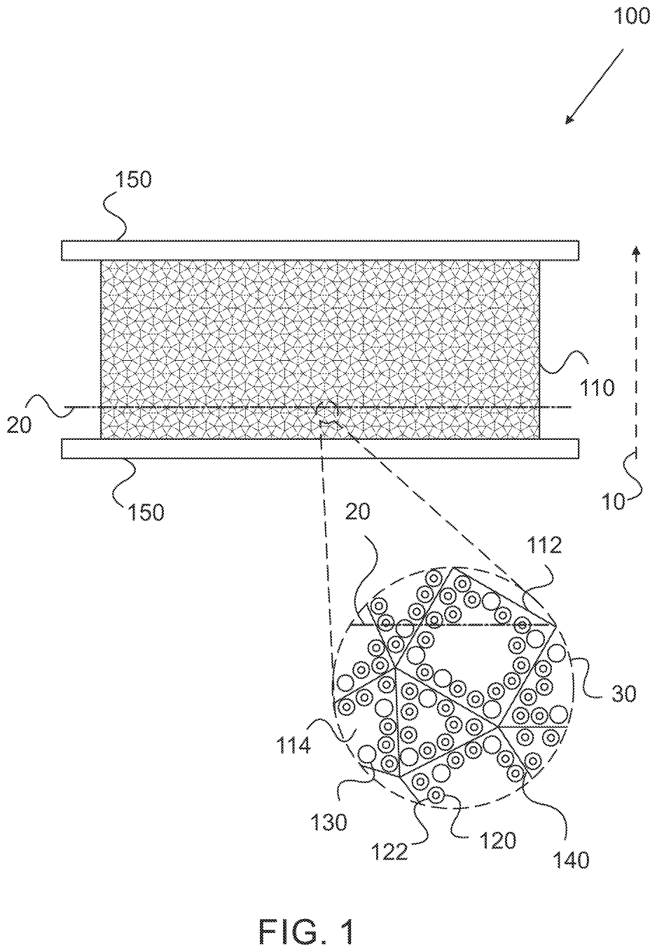

FIG. 1 (not in scale) schematically illustrates an example of an air filter 100 for preventing transmission of infections. The filter may be a breathing air filter, where the breathing air may be exhalation and/or inhalation air. Correspondingly, the filter may be a wearable filter for personal use and/or an air-handling filter for an extended space such as a room or an interior of a vehicle. In all these cases, the filter may act as an ambient air filter for filtering inhalation air. A personal-use filter, in particular, may alternatively or additionally act as an exhalation air filter for its user. The filter may be provided as personal protective equipment or as a part thereof for preventing transmission of infections. In general, the filter may also be provided as a coarse filter, for example in a face mask or a ventilation device. Similarly, the filter may be provided as a replaceable filter. The filter may be an active filter and/or a passive filter. In the former case, the filter may be powered by electricity.

In general, an apparatus may comprise one or more air filters 100 as disclosed. The apparatus may be a face mask for personal use. The apparatus may also be a ventilation and/or air conditioning apparatus, such as a ventilator, an air conditioner or an air handling unit. The apparatus may be configured for filtering ambient air. The apparatus may comprise an electric power connection and/or an electric power source for directing electric current into any or all of the one or more air filters.

The air filter 100 comprises or consists of a filter body 110, an active ingredient and a binder 140. The filter body is air-permeable and may therefore comprise one or more air flow paths 114 extending through the filter. For example, the filter body may comprise a larger number of small air flow paths extending through the filter body. The air flow paths may be separate, or they may intersect with each other. The filter body may, for example, comprise or be made of reticulated material, such as reticulated foam material. The filter body may also comprise or consist of a threaded mesh 112, which may be made of the reticulated material. The filter body may thereby comprise or consist of a mesh of threads, which may be nodally connected to each other. Some particularly suitable forms of providing the threaded mesh include a fiberglass filter, an open-porous mesh or a cloth filter. As an example, an open-porous mesh may be formed by a reticulated foam material such as a polymer foam. For this purpose, for example polyester or polyurethane foams may be used. The width of any air channels in the filter body may vary depending on the particular application. In some applications, the width may be, for example 1-3 millimeters and in some even larger. In some applications, the width may be smaller, for example 100-1000 micrometers, or even smaller, as long as the filter body and the filter remain air-permeable. In porous materials, the width may be described in terms of ppi-value (pores per inch), in which case the width may be, for example, 10-100 ppi.

While FIG. 1 illustrates a regular pattern for the threaded mesh 112, the mesh may also, and very typically, have a random or a semi-random pattern. The material of the filter body may be, for example a plastic material such as a plastic foam material, a fabric material or a fiber material such as glass fiber or carbon fiber. This allows the filter, for example, to be made light-weight. The filter body 110 may be of flexible material so that the air filter can be flexibly bent into shape. The filter may be arranged for air to pass through a depth dimension 10 of the filter body and, correspondingly, that of the filter. A filtering plane 20 may be defined perpendicular to this depth dimension. The filtering plane extend along the whole or partial depth of the filter body.

The active ingredient prevents transmission of infections by inactivating infection-transmitting micro-organisms. It comprises or consists of a plurality of particles having a core 120 of metallic copper with an electrically conductive coating 122, which can be formed as a film enclosing the core. The coating comprises or consists of silver, in particular metallic silver. Correspondingly, the plurality of particles can be provided in a metallic, electrically conductive state. For this, the copper and/or the silver may be substantially pure. It is noted that while the surface of the coating may be exposed to air, which may oxidize any silver on the surface of the coating, this should not be understood to change the fact that the coating, in overall, is electrically conductive, or metallic. The coating may be substantially homogeneous. The coating may be uniform or comprise silver nanoparticles, the latter of which has been found particularly useful in various applications. In particular, the outer surface of the coating may be irregular on the microscopic scale allowing metallic silver to directly interact with an infection-transmitting micro-organism from multiple directions simultaneously. This may allow notable decrease in inactivation time. Metallic bonding allows the plurality of particles, and the active ingredient, to be provided as an electrically conductive coating for the filter body 110, or the threaded mesh 112 thereof. In some applications, particularly for bacteria and viruses, electrical impedance of 0.015+/−0-0.005 Ohms has been found to provide particularly effective inactivation. The shape of the core may vary but in a specific example the core may be substantially spherical, which has been found to provide beneficial results. The size of the core may vary, but microparticles in particular have been found to provide beneficial results for inactivating respiratory viruses. The coating may correspond to a metallic silver film covering the core. The coating may completely cover the core. Nevertheless, it may be relatively thin, in particular less than a micron. It may have a substantially constant thickness across the core. The coating may effectively allow prevention of natural oxidization of copper for the active ingredient. The silver-coated copper particles for the active ingredient may be provided, for example, using a silver-coated copper conductive coating.

The active ingredient may comprise or consist of a mixture of metallic particles. In addition to the plurality of particles, the mixture may comprise or consist of additional particles 130, in particular silver particles and/or gold particles. This allows utilizing the naturally occurring antimicrobial properties of any particles, in particular silver, copper and, optionally, gold. In a specific embodiment, the active ingredient consists of the plurality of particles together with silver particles and/or gold particles. These particles may also be substantially pure and/or spherical. They may be microparticles, which has been found to provide improved inactivation effects. As these particles are of a single metal, they may be substantially homogeneous within their volume. These metallic particles for the active ingredient may be provided using a metal conductive coating, as well.

Any particle and/or core sizes indicated may be measurable as the largest diameter of the particle/core. This applies both when the particle/core is of regular shape, such as a sphere, or when it is of irregular shape.

The binder 140 binds the active ingredient to the filter body 110, for example to its mesh 112, in an air-permeable manner. For this purpose, any combination of an latex, polymethyl methacrylate (PMMA) and polyurethane may be used. In some applications, for example for dip coating, an epoxy and/or alkyd are particularly effective, alternatively or in addition to the above examples. Different binders may be used depending on the desired properties, such as mechanical and chemical properties, for binding. Some binders may improve, for example, durability, ultraviolet radiation susceptibility and/or flexibility of the air filter 100.

The filter body 110, or the inner and/or outer surfaces thereof, in the filtering plane is coated with the active ingredient and the binder 140, providing an inner and/or outer coating for the filter body. In this way, the filter body may be substantially thoroughly coated with the active ingredient in the filtering plane. This allows forcing any infection-transmitting micro-organisms passing through the filter body to be subjected to interaction with the active ingredient. An extended inner coating of the filter body in the depth dimension of the filter body facilitates extended interaction between the active ingredient and any infection-transmitting microorganisms. Correspondingly, providing an inner coating for the filter body along its whole depth dimension may be used to maximize the interaction. The inner coating may extend throughout the filter body, including both its lateral and depth dimensions. The binder may be provided as a substance that hardens during the formation of the connection for binding the active ingredient to the filter body. The hardening may take place through a chemical and/or a physical process. Alternative or additionally, the binder may comprise an additional hardening agent and/or a solvent, or binding may be facilitated utilizing a hardening agent and/or a solvent, which may be removed, for example by evaporation upon formation of the binding. The inner and/or outer surfaces of the filter body may be partially or thoroughly coated by the binder and the active ingredient. In either case, the inner and/or outer coating may consist solely of the binder and the active ingredient. In particular, the inner and/or outer coating may extend throughout the filtering plane 120. The inner and/or outer coating in the filtering plane 120 may be homogeneous or substantially homogeneous, even when it comprises a mixture of different kinds of particles. In particular, the inner and/or outer coating in the filtering plane may be metallic so that its electrical conductivity is high.

A blow-up 30 of the filter 100 illustrates the situation when the active ingredient comprising the plurality of particles 120, 122, optionally with additional particles 130 such as silver and/or gold particles, is embedded within the filter body 110 for inactivating infection-transmitting micro-organisms passing through the filter body. Any such microorganism passing through the filter body in its depth dimension 10 would need to pass through the filtering plane 20, which may also extend in the depth dimension, for example for the whole thickness of the filter body. The filter body 110 may have a threaded mesh 112 defining a skeletal structure into which the active ingredient can be bound with the binder 140. A mesh structure allows the active ingredient to be effectively and easily spread within the filtering plane or the whole filter body. The binding to the filter body can be performed so as to allow the active ingredient to directly interact with the micro-organisms. This may involve chemical and/or physical interactions, such as electric interactions. The active ingredient may be spread substantially homogeneously as an inner coating of the filter body in one or both lateral dimensions and/or the depth dimension.

The active ingredient, or the plurality of the particles therein, may be provided, for example, as a pigment such as a coating pigment. It may be applied to the filter body 110 by coating in a manner known to a person skilled in surface coating. Importantly, the active ingredient can be provided in an electrically conducting form. Consequently, the pigment is also metallic pigment. In some embodiments, increasing electric conductivity may be used to allow increasing inactivation of micro-organisms.

The active ingredient and/or the binder 140 may be applied to the filter body 110, for example, by spray coating and/or dip coating. This allows applying an inner and/or outer coating to the filter body as desired. This coating may be performed by a partially or fully automated system. Spray coating can be particularly effectively used to apply a low layer of active ingredient, whereas dip coating can be particularly effective for applying a high layer of active ingredient, as measured in how far in the depth dimension of the filter body the coating extends in absolute terms. In both cases, the thickness of the coating can be accurately controlled by the known binders. As an example, the inner and/or outer coating for the filter body may have an effective thickness of 10-50 micrometers, but it may also be smaller or larger, depending on the application. It has been found that an effective thickness of 15-30 micrometers may be used in various applications to provide improved results. Here, the expression ‘effective thickness’ is used as it should be understood that the thickness of the inner and/or outer coating may vary across the filter body, and it may even exceed ten times the effective thickness if the structure of the filter body permits agglomeration of the coating. Consequently, the effective thickness may here refer to the thickness of coating in the majority part of coated filter body. The filter body may be coated utilizing an additive for decreasing or removing surface tension for mitigating such agglomeration. This also allows improving air-permeability of the air filter. The binder and the active ingredient may be applied at the filter body separately or as a mixture. In either case, the binding may be formed as a substantially homogeneous mixture of the active ingredient and the binder, possibly including the hardening agent and/or the solvent. A thinning agent may be used to facilitate penetration of the active ingredient and/or binder into the filter body. This applies to both of the coating methods described below.

As an example of a dip coating arrangement, the air filter 100 may be manufactured by dipping the filter body 110 into a bath of liquid comprising the active ingredient. The arrangement may comprise a circulation pump, which may be used to circulate the liquid through the filter body. Continuous circulation may be used to improve the output of the process. The arrangement may also comprise one or more blenders for blending the liquid and thereby improving its homogeneity. With this, a sufficiently homogeneous liquid can be provided even with an active ingredient comprising relatively heavy metallic particles. One or more additives for decreasing or removing surface tension may be used, as indicated above. Also, an anti-skinning agent may be used to mitigate skinning.

As an example of spray coating, the active ingredient may be applied as a fluid. For various applications, a particularly effective coating may be provided with the fluid having viscosity of 12-30 seconds, in particular 13-18 seconds, as measured by DIN4 flow cup. The viscosity may be controlled by including thinning agent into the fluid.

In both of the above cases, the binder 140 may be applied with the active ingredient or separately, for example in a similar manner prior to applying the active ingredient.

The air filter 100 may comprise one or more air-permeable post filters 150. They may be positioned against the filter body 110 for mitigating the escape of infection-transmitting micro-organisms from the filter body, for example adjacent to the filter body or even in direct contact with the filter body. In particular, the filter body may be sandwiched between two such post-filters. The two post-filters here may have the same or different filtering properties with respect to each other. The use of a post-filter allows mitigating the escape of infection-transmitting microorganisms from the filter body, thereby increasing the interactions between the micro-organisms and the active ingredient. This may markedly increase the inactivation for both personal use and for use with an extended space. The post-filter may be, for example, a cloth and/or a paper-cloth filter. While the post-filter may define an asymmetric direction for the air filter, it does not necessarily need to. The air filter may be arranged for the post-filter to function also as a pre-filter.

In general, the air filter 100 may be provided as a symmetric filter so that its filtering properties are independent of the direction of the air flow in the depth dimension. On the other hand, while the filter body 110 with the active ingredient may be provided as a symmetric coarse filter, it may still be asymmetrically combined with one or more post-filters 150 for providing an asymmetric air filter. The symmetricity allows ease of use and reduction in risk of incorrect use. On the other hand, it allows the air filter to be equally and simultaneously used for preventing transmission of infections for both inhalation air and exhalation air, for example in a face mask.

The air filter 100 may also comprise an electrical connection for directing electric current into the active ingredient. This may be used to improve the inactivation capability of the air filter, for example by decreasing the inactivation time for inactivating infection-transmitting micro-organisms. While this may be used for both personal use and extended space air filters, particularly useful applications can be found for an air filter for an air-handling unit. The electrical connection may comprise a wired and/or a wireless connection for directing the electric current into the active ingredient. The air filter, or an apparatus comprising the air filter, may comprise an electric power source for providing the electric current.

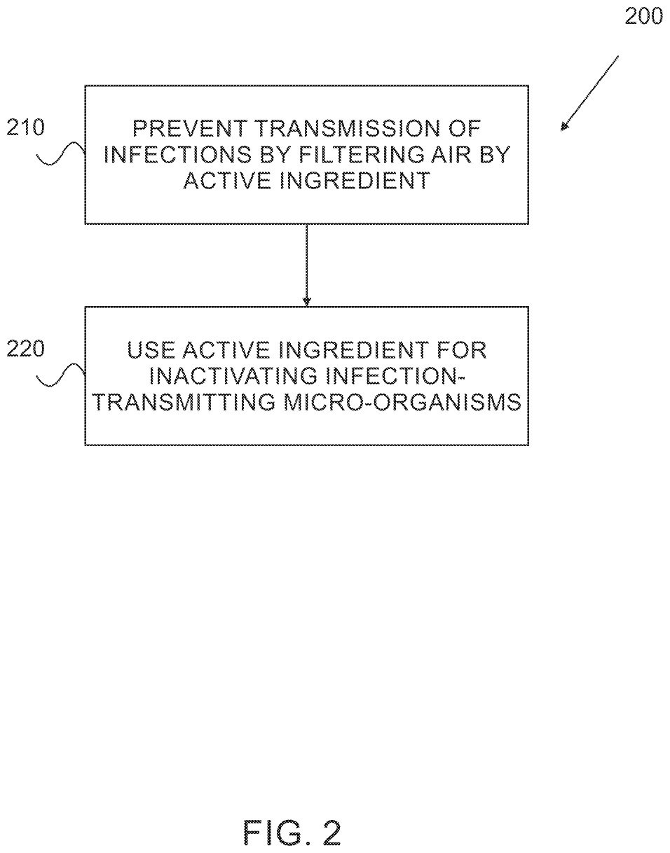

FIG. 2 illustrates a method 200 according to an example. As disclosed herein, the active ingredient comprising a plurality of particles having a core of metallic copper with an electrically conductive coating comprising or consisting of silver can be used 210 for inactivating infection-transmitting microorganisms. For this purpose, the active ingredient may be disposed in such a manner that it can come into direct contact with the micro-organisms. The contact may be repeated and/or timewise extended, for example within a filter material, allowing the probability of inactivating the micro-organisms to be increased. Transmission of infection by the micro-organisms may thereby be prevented 220 by filtering air with the active ingredient.

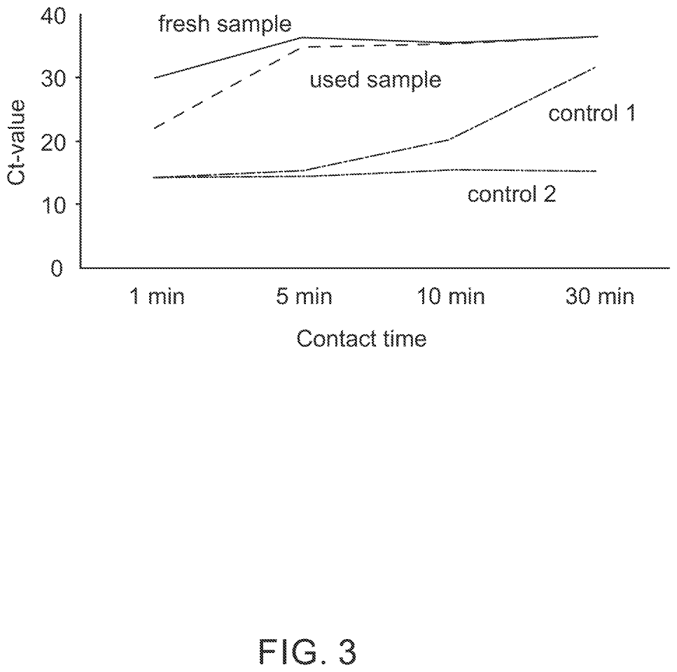

FIG. 3 illustrates some test results obtained for the active ingredient. Here, capability of the active ingredient to inactivate SARS-CoV-2 was tested. The solid line corresponds to a fresh sample and the dashed line to a heavily used sample. The remaining two lines are control samples: the single-dotted dash line corresponds to a copper surface, whereas the double-dotted dash line corresponds to a plastic-covered metal surface, which may be considered as an example of an uncoated filter body. The testing was performed in a biosafety-level-3 (BSL-3) laboratory with live SARS-CoV-2 from a cultured virus sample. The virus sample was applied on the active ingredient as well as control materials and allowed to air-dry in room temperature for 1 to 30 minutes. After this incubation time, a sample from the virus was added to susceptible cultured cells and the virus viability was tested by allowing virus to infect the cells for the duration of at least 5 days. During this time, if the virus is viable, it will cause a visible cytopathic effect on the cultured cells. Additionally, all samples were checked with qRT-PCR to measure the level of viral RNA copies (relative quantitation). The results are given as qRT-PCR Ct-values (a low value equals high amount of virus RNA). No cytopathic effect is observed when the Ct-value is >30 meaning that no infectious particles are present. Together these findings may be taken to show that in the conditions tested, the active ingredient inactivates the virus in less than one-minute contact time. On a used sample, viral RNA is still detected at minute, but this likely represents noninfectious particles as no cytopathic effect was observed in the cell culture.

Another test example is provided with respect to bacteria. Here, test method DM-DCLD-SOP-CP-2030 has been used. A sample with the active ingredient has been challenged with known quantity of test bacteria and allowed to dry in room temperature (10 minutes) at the area of 65 mm diameter and measured the number of surviving bacteria by surface contact plating and calculated the reduction for a period of time along with control sample. Based on the test conducted it has been observed that there is a complete reduction of test bacteria on the sample in 10 seconds after drying of inoculum. The results are outlined below in Table 1, where CFU stands for colony-forming unit.

TABLE 1

| | | | | Number of | | |
|---|---|---|---|---|---|---|
| | | | | bacteria after | | Antimicrobial |
| | Initial | | | 24 hr at 35° C. | | activity |
| Test | bacterial | | | Control | Test | Reduction |
| micro- | concentr. | | | (CFU/ | (CFU/ | percentage |
| organisms | (CFU/0.1 ml) | Duration | | Plate) | Plate) | (%) |
| Staphylococcus | 784 | 10 | seconds | 748 | <1 | 99.9 |
| aureus | | 30 | seconds | 732 | <1 | 99.9 |
| ATCC 6538 | | 1 | minute | 720 | <1 | 99.9 |
| Escherichia coli | 814 | 10 | seconds | 806 | <1 | 99.9 |
| ATCC 10536 | | 30 | seconds | 792 | <1 | 99.9 |
| | | 1 | minute | 788 | <1 | 99.9 |

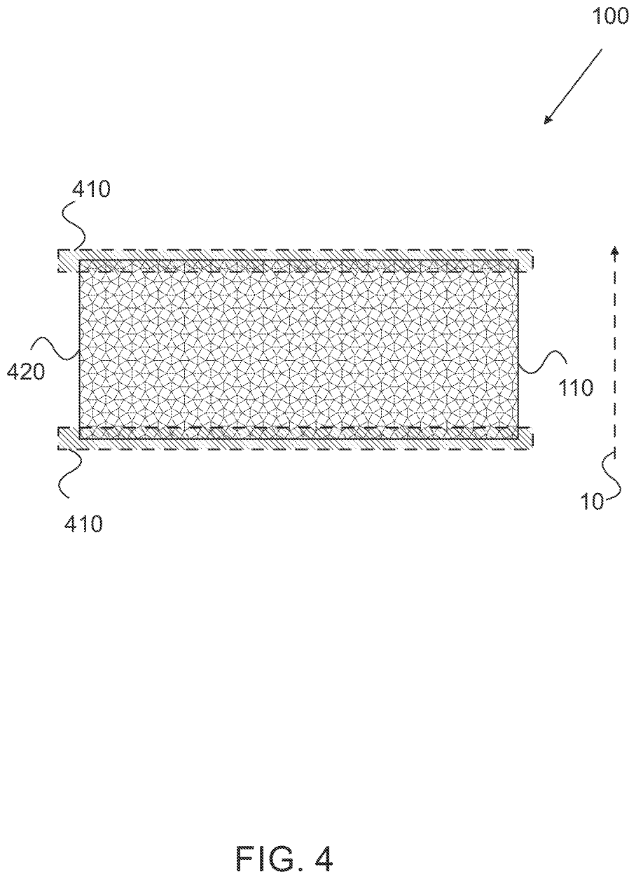

FIG. 4 illustrates an example of an air filter 100, which has the active ingredient as a surface application. Apart from this, the air filter may include any or all of the features described above—for example the one or more post-filters 150.

In this example, the active ingredient is not embedded throughout the filter body 110. Instead, it is provided on one or more outer surfaces 410 of the filter body, for example the front and/or rear surface, e.g. with respect to the air flow direction through the filter body. The active ingredient may therefore be used as an outer coating for the filter body, in the sense that it may coat any or all outer surfaces of the filter body. The active ingredient may still be applied across the whole the filtering plane, as described above, thereby providing a plane, where all surfaces of the filter body are coated with the active ingredient and through which any infection-transmitting micro-organisms need to pass to pass through the filter body. Such a plane may be formed at the front and/or at the rear surface.

The active ingredient here is not applied across the whole depth dimension of the filter body 110. After the outer surface 410 with the active ingredient, there is thus region free of the active ingredient. This region can extend across a whole filtering plane. It may correspond to the majority of the depth and/or volume of the filter body, for example 50-90 percent or even more. It may also comprise one of the front and the rear surface. In some applications, it may be desirable to have only one of the front and the rear surface covered with the active ingredient.

The air filter 100 according to any of the examples may comprise or consist of a HEPA (high-efficiency particulate air) filter and the example described in connection of FIG. 4 may have particular benefits with a HEPA filter. In such a case, the air filter may be configured for filtering matter from the air already at the outer surface of the filter body, which may result at the accumulation of matter, including micro-organisms, on the outer surface in question. The active ingredient at the outer surface of the filter body allows prevention of micro-organism growth on the outer surface. Such prevention can be particularly useful, when the air filter is not used in conjunction of air-circulating devices but with passive devices with respect to air circulation.

The active ingredient may be applied to the filter body by silk screen printing, in particular for HEPA filters, allowing the air filter to be provided as a filter roll, for example. Other techniques providing a filter roll may also be used. The active ingredient may be applied to the filter body by pad printing, rolling paint, robotic painting.

A filter roll may comprise multiple air filters 100 as disclosed herein. This can particularly be used when the air filters are HEPA filters. For example, the air filters may be connected to each other as a chain, such as a linear chain. Subsequent air filters may be detachable from each other, and for this purpose there may be a designated detachment region, such as a line of weakening, comprising e.g. any of perforation(s), groove(s), hollow(s) and recess(es) alone or in any combination, in the filter roll.

The manufacturing method for the air filter 100 may be roll to roll printing or utilizing spray manipulator. In particular, spray coating has been found as an efficient way for coating the air filter with the active ingredient. For this purpose, robotic spray coater may be used allowing accurate and efficient coating.

Unless otherwise indicated, the different functions discussed herein may be performed in a different order and/or concurrently with each other.

Any range or device value given herein may be extended or altered without losing the effect sought, unless indicated otherwise. Also, any example may be combined with another example unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The term ‘comprising’ is used herein to mean including the method, blocks or elements identified, but that such blocks or elements do not comprise an exclusive list and a method or apparatus may contain additional blocks or elements.

Although the invention has been the described in conjunction with a certain type of apparatus and/or method, it should be understood that the invention is not limited to any certain type of apparatus and/or method. While the present inventions have been described in connection with a number of examples, embodiments and implementations, the present inventions are not so limited, but rather cover various modifications, and equivalent arrangements, which fall within the purview of the claims. Although various examples have been described above with a certain degree of particularity, or with reference to one or more individual embodiments, those skilled in the art could make numerous alterations to the disclosed examples without departing from the scope of this specification.

1. An air filter for preventing transmission of infections, comprising:
an air-permeable filter body;
an active ingredient comprising a plurality of particles having a core of metallic copper with an electrically conductive coating comprising silver; and
a binder for binding the active ingredient to the air-permeable filter body.

2. The air filter according to claim 1, wherein the filter body comprises a threaded mesh.

3. The air filter according to claim 1, wherein the active ingredient comprises at least 90 percent by weight of the plurality of particles.

4. The air filter according to claim 1, wherein the active ingredient comprises additional metallic particles, which are silver particles and/or gold particles.

5. The air filter according to claim 4, wherein the active ingredient comprises 1-10 percent by weight of the additional particles.

6. The air filter according to claim 1, wherein the plurality of particles are microparticles.

7. The air filter according to claim 1, wherein the thickness of the coating is less than a micrometer.

8. The air filter according to claim 1, comprising an electrical connection for directing electric current into the active ingredient.

9. The air filter according to claim 1, wherein the binder is selected from a group consisting of an alkyd, epoxy, latex, polymethyl methacrylate (PMMA) and polyurethane.

10. The air filter according to claim 1 comprising a first air-permeable post-filter positioned against the filter body for mitigating the escape of infection-transmitting micro-organisms from the filter body.

11. The air filter according to claim 10, comprising a second air-permeable post-filter positioned against the filter body for mitigating the escape of infection-transmitting micro-organisms from the filter body; wherein the filter body is sandwiched between the first and the second post-filter.

12. The air filter according to claim 1, wherein the active ingredient is provided on one or more outer surfaces of the filter body as a surface application.

13. A face mask comprising the air filter according to claim 1 for filtering breathing air.

14. A ventilation and/or air conditioning apparatus comprising the air filter according to claim 1 for filtering air passing through the apparatus.

15. A filter roll comprising a plurality of air filters according to claim 1, wherein the plurality of air filters are joined together as a chain where subsequent air filters are detachable from each other.

16. The filter roll according to claim 15, wherein the plurality of air filters are HEPA filters.

17. A method for preventing transmission of infections by filtering air with an active ingredient comprising a plurality of particles having a core of metallic copper with an electrically conductive coating comprising silver.

18. The use of an active ingredient comprising a plurality of particles having a core of metallic copper with an electrically conductive coating comprising silver for inactivating infection-transmitting micro-organisms.

19. A method of manufacturing the air filter according to claim 1, wherein the method comprises spray coating one or more outer surfaces of the filter body with the active ingredient.
